(19) United States
(12) Patent Application Publication
(10) Pub. No.: US 2009/0001748 A1
(43) Pub. Date: Jan. 1, 2009

(54) Trim Assembly For A Vehicle

(75) Inventors: Steven G. Brown, Birmingham, MI (US); Timothy P. Parkin, Clarkston, MI (US); Jerome J. Ennis, Windsor (CA); Michael P. Fahey, Harrison Township, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: BBI ENTERPRISES GROUP, INC., Bloomfield Hills, MI (US)

(21) Appl. No.: 12/164,370

(22) Filed: Jun. 30, 2008

Related U.S. Application Data
(60) Provisional application No. 60/937,690, filed on Jun. 29, 2007.

(51) Int. Cl. B60R 7/00

(52) U.S. Cl. 296/37.8

(57) ABSTRACT

A trim assembly for an interior of a passenger compartment of a vehicle comprises a first panel, a first shell, and a second shell. The first panel forms interior trim for the vehicle and defines a first receptacle. The first shell defines a convex surface and a concave surface and is removably coupled within the first receptacle so that one of the convex surface and the concave surface is exposed. The second shell defines a convex surface and a concave surface and is matable to the first shell to define a case. The case is removable from the first receptacle.

### RELATED APPLICATIONS

This application claims priority to and all advantages of U.S. Provisional Patent Application No. 60/937,690, which was filed on Jun. 29, 2007.

### BACKGROUND OF THE INVENTION

1. Field of the Invention

The subject invention generally relates to trim assemblies for an interior of a passenger compartment of a vehicle. More specifically, the subject invention relates to a trim assembly including a removable case.

2. Description of the Related Art

Trim assemblies for vehicles are typically useful for improving the aesthetics and functionality of an interior of a passenger compartment of a vehicle. For example, trim assemblies such as headliners typically add color and texture to the passenger compartment, whereas trim assemblies such as door bolsters typically add support and comfort to the passenger compartment. Further, one type of trim assembly, a rear quarter panel trim assembly, is especially useful for providing a finished appearance to passenger compartments of large-capacity vehicles, such as mini-vans, sport utility vehicles, and limousines.

Trim assemblies are typically designed to mask underlying vehicle support structures, such as steel body frames, wiring harnesses, and sound system components. Often, in the case of large-capacity vehicles, trim assemblies mask significant void space between rear support pillars of the vehicle. Such void space is typically ideal for storage of small items, e.g. maps, bottles, towels, flashlights, etc., but is often inaccessible to vehicle occupants. To capitalize on the significant void space between rear support pillars of vehicles, some existing trim assemblies include storage. For example, existing trim assemblies may include receptacles, partitions, retainers, and/or cases to allow for item storage.

However, many existing trim assemblies provide storage that encroaches into the interior of the passenger compartment of the vehicle, i.e., storage that protrudes from the trim assembly. Protruding storage decreases available space in the passenger compartment, and can hinder transportation of large or bulky items.

Further, many existing trim assemblies only include fixed, i.e., non-removable, storage. Non-removable storage is less convenient than removable storage since items stored in non-removable storage must be transferred to other storage and transportation means, such as bags, purses, or luggage, before the items are removed from the vehicle.

Moreover, many existing trim assemblies that provide for storage pose a risk to vehicle occupants. That is, many existing trim assemblies do not secure loose items sufficiently and do not protect against ejection of loose items into the passenger compartment of the vehicle. Or, many existing trim assemblies include storage that may open or spill loose contents into the passenger compartment of the vehicle. Further, many existing trim assemblies include storage that may shift and/or be ejected into the passenger compartment of the vehicle during vehicle use. Loose items can injure or distract vehicle occupants.

Further, many existing trim assemblies do not sufficiently protect stored items. That is, many existing trim assemblies do not provide sturdy storage and do not protect against damage to stored items from jostling or puncture.

Finally, many existing trim assemblies are not supplied to a vehicle manufacturer as an integrated unit. Trim assemblies supplied in multiple components adversely affect production costs associated with component tracking and vehicle assembly.

Due to the inadequacies of existing trim assemblies, there remains an opportunity to provide a trim assembly for an interior of a passenger compartment of a vehicle which does not suffer from the aforementioned inadequacies.

### SUMMARY OF THE INVENTION AND ADVANTAGES

The subject invention provides a trim assembly for an interior of a passenger compartment of a vehicle. The trim assembly comprises a first panel, a first shell, and a second shell. The first panel forms interior trim for the vehicle and defines a first receptacle. The first shell defines a convex surface and a concave surface and is removably coupled within the first receptacle so that one of the convex surface and the concave surface is exposed. The second shell defines a convex surface and a concave surface and is matable to the first shell to define a case. The case is removable from the first receptacle.

The subject invention also provides the trim assembly further comprising a second panel. The second panel opposes the first panel and defines a second receptacle for receiving the second shell independently from the first shell.

The trim assembly of the subject invention provides additional storage space in the interior of the passenger compartment of the vehicle. Further, the case of the trim assembly is removable from the vehicle and minimizes transfer of stored items to other storage and transportation means before the items are removed from the vehicle. The case of the trim assembly does not encroach into the interior of the passenger compartment of the vehicle and thus does not interfere with transportation of large or bulky items. Further, the trim assembly of the subject invention secures loose items sufficiently and minimizes ejection of loose items into the passenger compartment of the vehicle, thereby minimizing risks to vehicle occupants. The case of the trim assembly secures and protects stored items and remains coupled to interior trim of the vehicle during vehicle use. The case is sturdy and protects against damage to stored items from jostling or puncture. Finally, the trim assembly is supplied to a vehicle manufacturer as an integrated unit, thereby minimizing production costs associated with component tracking and vehicle assembly.

### BRIEF DESCRIPTION OF THE DRAWINGS

Other advantages of the present invention will be readily appreciated, as the present invention becomes better understood by reference to the following detailed description when considered in connection with the accompanying drawings wherein:

FIG. 1 is a perspective view of a trim assembly in a passenger compartment of a vehicle;

FIG. 2 is a perspective view of a first panel, a first shell, and a second shell;

FIG. 3 is a perspective view of the first panel, including a first receptacle and an additional receptacle;

FIG. 4 is a perspective view of the first panel, the first receptacle, the additional receptacle, and a storage bag;

FIG. 5 is a perspective view of the first shell removably coupled to the second shell to define a case;

FIG. 6 is a second perspective view of the case;

FIG. 7 is a depiction of the case in use outside of the vehicle;

FIG. 7A is a perspective view of the first shell;

FIG. 8 is a perspective view of a second panel; and

FIG. 9 is a perspective view of the second panel, the first shell, and the second shell.

### DETAILED DESCRIPTION OF THE INVENTION

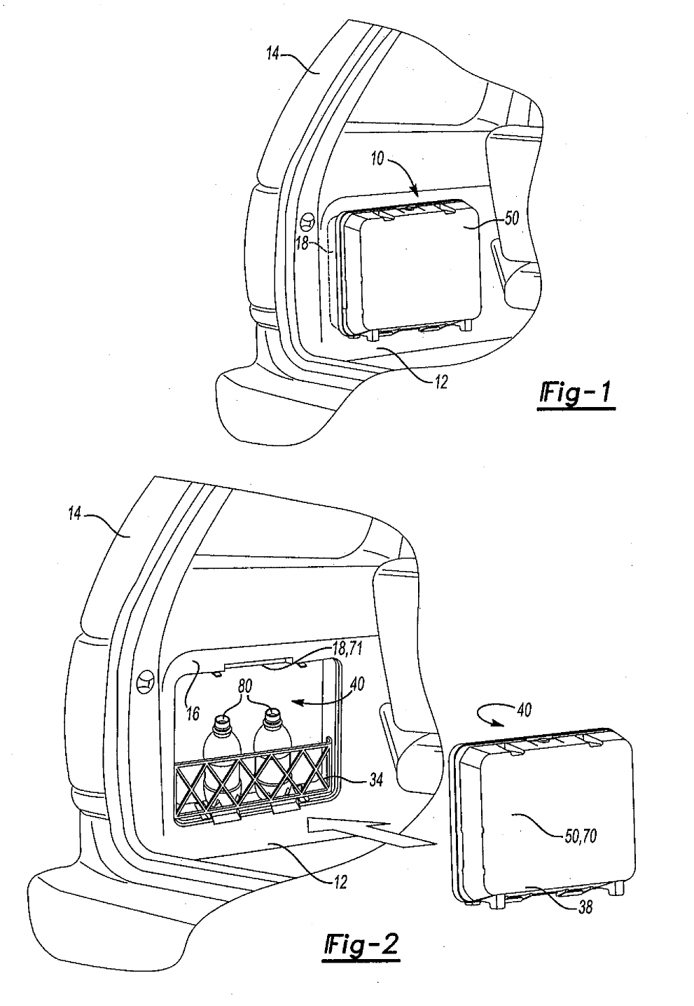

Referring to the Figures, wherein like numerals indicate like or corresponding parts throughout the several views, the present invention includes a trim assembly 10 for an interior of a passenger compartment 12 of a vehicle 14, as generally shown in FIGS. 1, 2, 4, and 9. The trim assembly 10 typically improves aesthetics and functionality for the interior of the passenger compartment 12 of the vehicle 14. More specifically, the trim assembly 10 typically provides interior trim and additional storage in the interior of the passenger compartment 12 of the vehicle 14, specifically in rear quarter panels of the vehicle 14. However, it is to be appreciated that the trim assembly 10 of the present invention can have applications beyond rear quarter panels of vehicles, such as tailgate panels and door panels for vehicles. Further, it is to be appreciated that the trim assembly 10 of the present invention can have applications beyond automotive applications, such as marine and aerospace applications.

As set forth in FIGS. 1-3, the trim assembly 10 comprises a first panel 16 and a first shell 18. The first panel 16 forms interior trim for the vehicle 14 and defines a first receptacle 20. In one embodiment, the first panel 16 typically forms interior trim for a rear quarter panel of the vehicle 14. That is, without intending to be limited by theory, the first panel 16 typically attaches to the interior of the passenger compartment 12 of the vehicle 14 between rear support pillars (not shown), i.e., a C-pillar and a D-pillar, of the vehicle 14. It is to be appreciated that the trim assembly 10 may also attach to any other suitable location in the interior of the passenger compartment 12 of the vehicle 14, such as between other support pillars. The first panel 16 typically comprises means for attachment to the vehicle 14, such as tabs, grooves, guide holes, and/or bolts, and may be custom designed to complement contours and design elements, i.e., sound system components, wiring harnesses, etc., of the vehicle 14. The first panel 16 may be formed from any suitable material known in the art, such as steel or a polymer, and may be covered with any suitable material known in the art, such as, but not limited to, polymer, plastic, vinyl, felt, leather, wood, veneer, paint, or coatings. That is, typically, the first panel 16 is covered for improved aesthetics of the interior of the passenger compartment 12 of the vehicle 14.

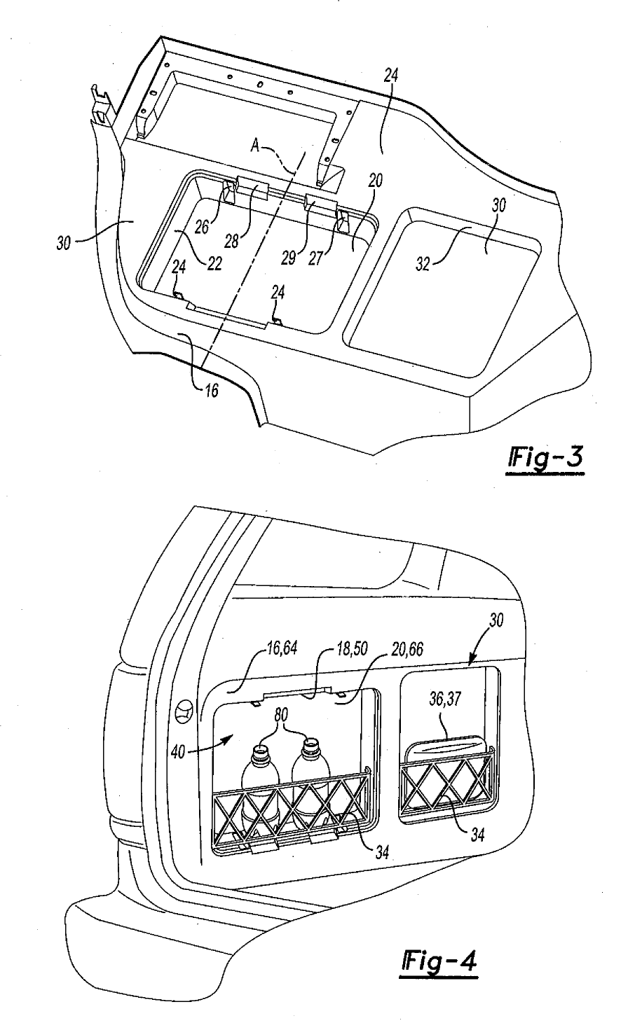

As shown in FIG. 3, the first receptacle 20 typically defines a first periphery 22 including a locking member, generally indicated at 24. That is, the first receptacle 20 typically extends inwardly away from the interior of the passenger compartment 12 of the vehicle 14 toward an exterior of the vehicle 14 to define the first periphery 22. It is to be appreciated that the first receptacle 20 may be disposed in any suitable location in the first panel 16. That is, the first receptacle 20 may be disposed centrally or near an edge of the first panel 16. The first receptacle 20 typically receives the first shell 18, as set forth in more detail below.

Without intending to be limiting, the locking member 24 may be defined as at least one tab. It is to be appreciated that the locking member 24 may be a flexible tab or a rigid tab. It is also to be appreciated that the locking member 24 may include a plurality of tabs or that the tabs may be eliminated. It is further to be appreciated that the locking member 24 may be a hook, a snap, a hook and loop fastener, e.g. Velcro®, a latch, a magnet, an interference fit, a friction fit, or any other acceptable locking member 24.

It is also to be appreciated that the locking member 24 may be disposed anywhere on the first periphery 22, proximal to the first periphery 22, or in any other suitable location. When in use, the locking member 24 typically retains the first shell 18 in the first receptacle 20 of the first panel 16, as set forth in more detail below.

Referring to FIGS. 2 and 3, the first periphery 22 typically defines a recession, generally indicated at 26, extending away from the first receptacle 20. The recession 26 is typically opposite the locking member 24 of the first receptacle 20. That is, the recession 26 and the locking member 24 typically operate in tandem to retain the first shell 18 in the first receptacle 20 of the first panel 16. More specifically, the recession 26 typically retains a proximal portion of the first shell 18 while the locking member 24 typically retains a distal portion of the first shell 18. It is to be appreciated that the first periphery 22 may define a plurality of recessions 26, for example, two recessions 26, 27 with each recession 26, 27 extending away from the first receptacle 20. In an embodiment where the first periphery 22 defines a plurality of recessions 26, 27, each recession 26, 27 is typically disposed equidistant apart from a central axis A.

The first periphery 22 typically defines a well, generally indicated at 28, spaced apart from the recession 26 and opposite the locking member 24 of the first receptacle 20. The well 28 is typically opposite the locking member 24 of the first receptacle 20. That is, the well 28 and the locking member 24 typically also operate in tandem to retain the first shell 18 in the first receptacle 20 of the first panel 16. It is to be appreciated that the first periphery 22 may define a plurality of wells 28, for example, two wells 28, 29, with each well 28, 29 extending away from the first receptacle 20. In an embodiment where the first periphery 22 defines a plurality of wells 28, 29, each well 28, 29 is typically disposed equidistant apart from a central axis A.

In one embodiment, the first panel 16 further comprises an additional receptacle, generally indicated at 30. The additional receptacle 30 is different from the first receptacle 20. As shown in FIG. 3, the additional receptacle 30 typically defines an additional periphery, generally indicated at 32. That is, the additional receptacle 30 typically extends inwardly away from the interior of the passenger compartment 12 of the vehicle 14 towards the exterior of the vehicle 14 to define the additional periphery 32. It is to be appreciated that the additional receptacle 30 may be disposed in any suitable location in the first panel 16. That is, the additional receptacle 30 may be disposed centrally or near an edge of the first panel 16.

Referring additionally to FIG. 4, the additional receptacle 30 typically includes a retainer, generally indicated at 34. The retainer 34 is typically a cargo net, i.e., flexible and stretchable netting, that is attached to the additional periphery 32 of the additional receptacle 30. However, it is to be appreciated that the retainer 34 may include a plurality of cargo nets or that the cargo nets may be eliminated. It is further to be appreciated that the retainer 34 may be any means for retaining, such as a hook, a snap, a hook and loop fastener, e.g. Velcro®, a latch, an arm, a magnet, an interference fit, a friction fit, or any other acceptable retainer 34. It is also to be appreciated that the retainer 34 may be disposed anywhere on the additional periphery 32, proximal to the additional periphery 32, or in any other suitable location.

Referring to FIG. 4, in one embodiment, the trim assembly 10 further comprises a storage bag, generally indicated at 36. The storage bag 36 is typically soft-sided and moldable. That is, the storage bag 36 is typically fabricated from a fabric or a flexible plastic. The storage bag 36 typically includes at least one opening for insertion of an item, generally indicated at 80, to be stored. The storage bag 36 is typically removably retained within the additional receptacle 30 of the first panel 16 by the retainer 34. That is, the retainer 34 typically retains the storage bag 36 in the additional receptacle 30 of the first panel 16. When in use, the additional receptacle 30 typically receives the storage bag 36, and when not in use, the storage bag 36 may be removed from the additional receptacle 30 and/or from the vehicle 14.

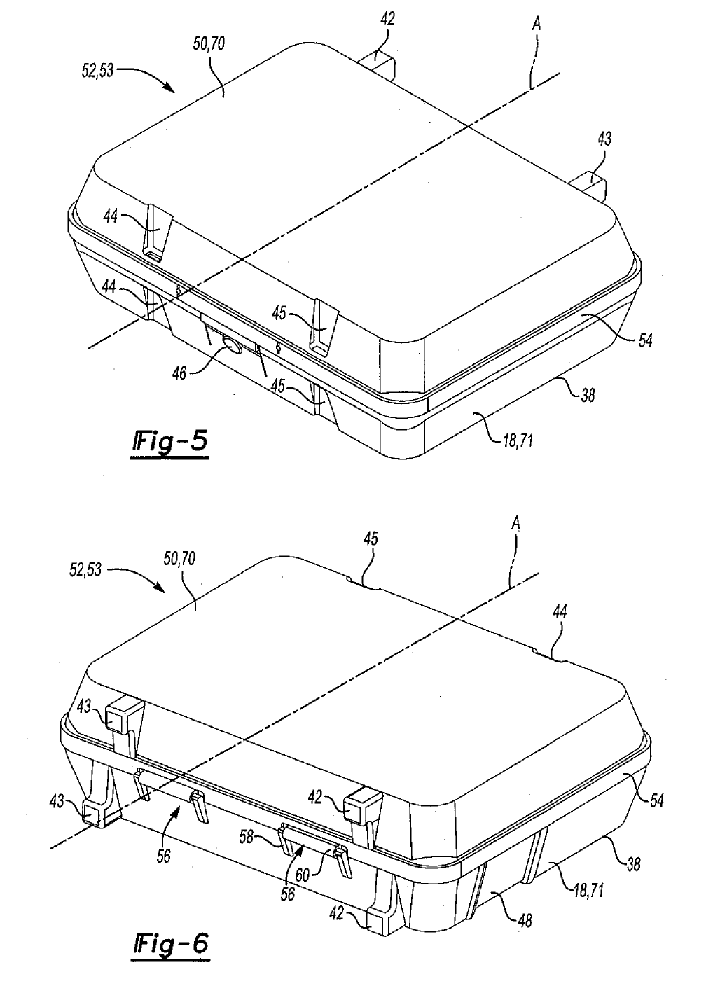

Referring to FIGS. 4 and 5, the trim assembly 10 comprises the first shell 18. The first shell 18 defines a convex surface 38 and a concave surface 40. That is, the first shell 18 typically defines a storage space for items 80, including maps, bottles, towels, flashlights, disks, documents, accessories, etc. The first shell 18 is removably coupled within the first receptacle 20 so that one of the convex surface 38 and the concave surface 40 is exposed. That is, the first shell 18 is removable from the first receptacle 20 and/or from the vehicle 14.

Referring to FIGS. 3 and 6, the first shell 18 typically further comprises a protrusion, generally indicated at 42, that is complementary in configuration to the recession 26 of the first periphery 22 of the first receptacle 20. That is, the protrusion 42 typically extends outward away from the first shell 18. The protrusion 42 is typically useful as a locating peg for removably coupling the first shell 18 within the first receptacle 20. That is, to removably couple the first shell 18 within the first receptacle 20, a user typically aligns the protrusion 42 with the recession 26 so that the recession 26 receives the protrusion 42. Since the protrusion 42 is complementary in configuration to the recession 26 of the first receptacle 20, the protrusion 42 typically fits snugly within and is surrounded by the recession 26.

It is to be appreciated that the first shell 18 may include a plurality of protrusions 42, 43, or that the protrusion 42 may be eliminated. In one embodiment, the first shell 18 typically includes two protrusions 42, 43. In addition to acting as a locating peg for removably coupling the first shell 18 within the first receptacle 20, the protrusions 42, 43 are also typically useful as legs upon which the first shell 18 can stand, i.e., remain in a vertical position.

It is to be appreciated that the protrusion 42 may be disposed in any suitable location on the first shell 18. In the embodiment including a plurality of protrusions 42, 43, the protrusions 42, 43 are typically spaced equidistant apart from the central axis A.

Referring to FIGS. 4 and 5, the first shell 18 may further define an indentation, generally indicated at 44, that is opposite the protrusion 42 of the first shell 18. That is, the convex surface 38 of the first shell 18 typically defines the indentation 44. The indentation 44 is typically complementary in configuration to the locking member 24 of the first periphery 22 of the first receptacle 20. The indentation 44 typically extends inward on the convex surface 38 of the first shell 18. The indentation 44 is typically useful as a retention means for removably coupling the first shell 18 within the first receptacle 20. That is, to removably couple the first shell 18 within the first receptacle 20, a user typically aligns the protrusion 42 with the recession 26 so that the recession 26 receives the protrusion 42, which thereby aligns the indentation 44 with the locking member 24 so that the indentation 44 receives the locking member 24, and removably couples, i.e., lodges, the first shell 18 into place within the first receptacle 20. Since the indentation 44 is complementary in configuration to the locking member 24 of the first receptacle 20, the locking member 24 typically fits snugly within and is surrounded by the indentation 44.

It is to be appreciated that the first shell 18 may include a plurality of indentations 44, 45 or that the indentation 44 may be eliminated. In one embodiment, the first shell 18 typically includes two indentations 44, 45.

Further, it is to be appreciated that the indentation 44 may be disposed in any suitable location on the first shell 18, as long as the indentation 44 is opposite the protrusion 42 of the first shell 18. In the embodiment including a plurality of indentations 44, 45, the indentations 44, 45 are typically spaced equidistant apart from the central axis A. Typically, the indentation 44 is disposed between the central axis A and the protrusion 42.

Referring to FIGS. 2 and 4, the first shell 18 may further comprise the retainer 34. That is, the first shell 18 may include the cargo net. The retainer 34 is typically useful for retaining items 80 within the concave surface 40 of the first shell 18. The retainer 34 may include any suitable means for retaining as set forth above.

Referring to FIG. 5, the first shell 18 may further comprise a closure means, generally indicated at 46. The closure means 46 may be any suitable closure means 46 as known in the art, such as a latch, a snap, a tab, an arm, a hook, a hook and loop fastener, e.g. Velcro®, a button, a notch, and/or a magnet.

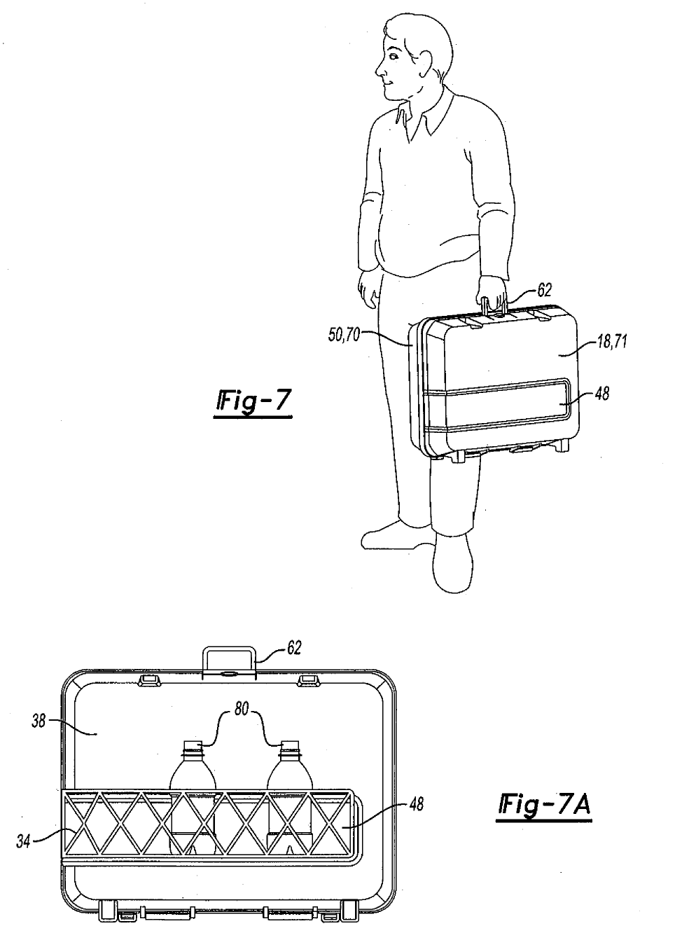

Referring to FIGS. 6, 7, and 7A, the first shell 18 may further comprise a channel 48 on the convex surface 38 of the first shell 18. The channel 48 typically includes the retainer 34. For example, the channel 48 may include the cargo net. The retainer 34 typically retains items 80 that may be stored in the channel 48. As such, the channel 48 is typically useful for retaining items 80, e.g. a bottle, within easy reach of a user. That is, the channel 48 typically defines a pocket on the convex surface 38 of the first shell 18 that the user can access without reaching into the concave surface 40 of the first shell 18.

Referring back to FIG. 2, when in use for storage in the vehicle 14, the first shell 18 typically includes five sides to define a storage space. Further, the first shell 18 is typically substantially received within the first receptacle 20 so that the first shell 18 is disposed substantially flush to the first panel 16. It is to be appreciated that the terminology substantially flush means that the first shell 18 is typically seated within the first receptacle 20 of the first panel 16 so that the first shell 18 does not encroach into the interior of the passenger compartment 12 of the vehicle 14. The concave surface 40 of the first shell 18 is typically visible from the interior of the passenger compartment 12 of the vehicle 14, but is recessed within the first panel 16 so as not to encroach into the passenger compartment 12 of the vehicle 14, thus not interfering with transportation of large or bulky items 80 in the passenger compartment 12 of the vehicle 14.

Referring to FIGS. 2 and 5-7, the trim assembly 10 comprises a second shell, generally indicated at 50, defining a convex surface 38 and a concave surface 40. That is, the second shell 50 typically defines a storage space for items 80. The second shell 50 is matable to the first shell 18 to define a case 52 that is removable from the first receptacle 20 of the first panel 16. Additionally, the case 52 is also removable from the vehicle 14.

Referring to FIG. 6, the second shell 50 typically further comprises a protrusion, generally indicated at 42, that is complementary in configuration to the protrusion 42 of the first shell 18. That is, the protrusion 42 typically extends outward away from the second shell 50.

It is to be appreciated that the second shell 50 may include a plurality of protrusions 42, 43, or that the protrusion 42 may be eliminated. In one embodiment, the second shell 50 typically includes two protrusions 42, 43. The protrusions 42, 43 are typically useful as legs upon which the second shell 50 can stand, i.e., remain in a vertical position.

It is to be appreciated that the protrusion 42 may be disposed in any suitable location on the second shell 50. In the embodiment including a plurality of protrusions 42, 43, the protrusions 42, 43 are typically spaced equidistant apart from the central axis A.

Referring to FIG. 5, the second shell 50 may further define an indentation, generally indicated at 44, that is opposite the protrusion 42 of the second shell 50. That is, the convex surface 38 of the second shell 50 typically defines the indentation 44. The indentation 44 typically extends inward on the convex surface 38 of the second shell 50.

It is to be appreciated that the second shell 50 may include a plurality of indentations 44, 45, or that the indentation 44 may be eliminated. In one embodiment, the second shell 50 typically includes two indentations 44, 45.

Further, it is to be appreciated that the indentation 44 may be disposed in any suitable location on the second shell 50, as long as the indentation 44 is opposite the protrusion 42 of the second shell 50. In the embodiment including a plurality of indentations 44, 45, the indentations 44, 45 are typically spaced equidistant apart from the central axis A. Typically, the indentation 44 is disposed between the central axis A and the protrusion 42.

As shown in FIG. 4, the second shell 50 may further comprise the retainer 34. That is, the first shell 18 and/or the second shell 50 typically comprise the retainer 34. That is, the second shell 50 may include the cargo net. The retainer 34 is typically useful for retaining items 80 within the concave surface 40 of the second shell 50. The retainer 34 may include any suitable means for retaining as set forth above.

The second shell 50 also typically includes five sides to define a storage space. As shown in FIGS. 5 and 6, the second shell 50 typically further comprises a lip 54. The lip 54 typically contacts and surrounds the first shell 18 when the first shell 18 is mated to the second shell 50 to define the case 52. Referring to FIG. 5, in one embodiment, the second shell 50 is removably coupled to the first shell 18 via an interference fit so that the lip 54 of the second shell 50 contacts and surrounds the first shell 18. That is, the second shell 50 is matable to the first shell 18 to define the case 52. The case 52 is removable from the interior of the passenger compartment 12 of the vehicle 14 and provides a transportable, removable storage space for items 80. That is, the first shell 18 and the second shell 50 each typically include five sides to define the storage space. When removably coupled, i.e., mated, the first shell 18 and the second shell 50 define the case 52 which encloses the storage space. In one embodiment, the closure means 46 of the first shell 18 typically contacts the lip 54 of the second shell 50 so that the case 52 remains in a closed, i.e., mated or coupled, position. It is to be appreciated that the first shell 18 and the second shell 50 may be mated to define the case 52 inside the passenger compartment 12 of the vehicle 14, i.e., in the first receptacle 20, or may be mated to define the case 52 outside the passenger compartment 12 of the vehicle 14.

In another embodiment, the second shell 50 is removably coupled to the first shell 18 via a hinge 56. The hinge 56 typically provides means for separating distal edges of the first shell 18 and the second shell 50 while proximal edges of the first shell 18 and the second shell 50 remain in contact. That is, the first shell 18 typically includes a first portion 58 of the hinge 56 that is received by the well 28 of the first receptacle 20 when the first shell 18 is removably coupled within the first panel 16. That is, the well 28 may be a seat for the first portion 58 of the hinge 56 of the first shell 18. More specifically, the well 28 typically retains the first portion 58 of the hinge 56 of the first shell 18 while the locking member 24 of the first receptacle 20 typically retains a distal portion of the first shell 18. Moreover, the second shell 50 typically includes a second portion 60 of the hinge 56. The first portion 58 and the second portion 60 typically mate to form the hinge 56 which pivots to open and close the case 52.

Referring to FIGS. 3 and 6, the first portion 58 is complementary in configuration to the well 28 of the first periphery 22 of the first receptacle 20. That is, the first portion 58 typically extends outward away from the first shell 18. To removably couple the first shell 18 within the first receptacle 20, a user typically aligns the first portion 58 with the well 28 so that the well 28 receives the first portion 58. Since the first portion 58 is complementary in configuration to the well 28 of the first periphery 22, the first portion 58 typically fits snugly within and is surrounded by the well 28.

Referring to FIGS. 7 and 7A, the first shell 18 or the second shell 50 may further comprise a handle 62. The handle 62 is typically useful for carrying the case 52, as shown in FIG. 7. The handle 62 is typically retractable. That is, the handle 62 typically recedes into the first shell 18 or the second shell 50 when not in use.

Notably, the case 52 is typically removably coupled within the first receptacle 20 prior to attaching the first panel 16 to the interior of the passenger compartment 12 of the vehicle 14. That is, the trim assembly 10 is typically supplied to a manufacturer of the vehicle 14 as an integrated unit, i.e., as a prefabricated unit. The trim assembly 10 is typically pre-assembled for insertion into the passenger compartment 12 of the vehicle 14. Consequently, the trim assembly 10 typically minimizes production costs associated with component tracking and vehicle assembly. That is, the trim assembly 10 minimizes problems and costs associated with lost or missing components, assembly times for vehicles, and misaligned quantities of components, i.e, too many or too few shells per panel.

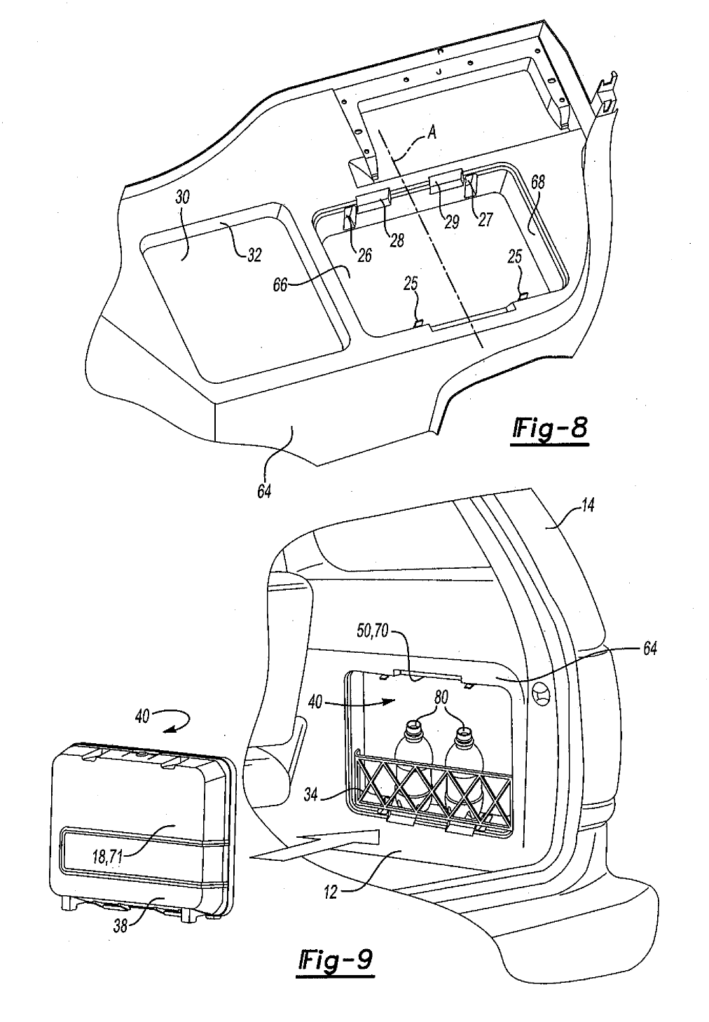

Referring to FIG. 8, in one embodiment, the trim assembly 10 comprises a second panel, generally indicated at 64. The second panel 64 opposes the first panel 16 and defines a second receptacle 66 for receiving the second shell 50 independently from the first shell 18.

The second panel 64 typically forms interior trim for the vehicle 14 and defines the second receptacle 66. In one embodiment, the second panel 64 typically forms interior trim for a rear quarter panel (not shown) of the vehicle 14. That is, without intending to be limited by theory, the second panel 64 typically attaches to the interior of the passenger compartment 12 of the vehicle 14 between rear support pillars (not shown), i.e., the C-pillar and the D-pillar, of the vehicle 14. It is to be appreciated that the second panel 64 may also attach to any other suitable location in the interior of the passenger compartment 12 of the vehicle 14, such as between other support pillars. The second panel 64 typically comprises means for attachment to the vehicle 14, such as tabs, grooves, guide holes and/or bolts, and may be custom designed to complement contours and design elements, i.e., sound system components, wiring harnesses, etc., of the vehicle 14. The second panel 64 may be formed from any suitable material known in the art, such as steel or a polymer, and may be covered with any suitable material known in the art, such as, but not limited to, polymer, plastic, vinyl, felt, leather, wood, veneer, paint, or coatings. That is, typically, the second panel 64 is covered for improved aesthetics of the interior of the passenger compartment 12 of the vehicle 14.

The second panel 64 is typically substantially similar to the first panel 16. The terminology substantially similar means that the second panel 64 typically includes parallel features to the first panel 16. That is, the second panel 64 is typically a mirror image of the first panel 16 across a center z-axis of the interior of the passenger compartment 12 of the vehicle 14. For example, in an embodiment where the first panel 16 is attached to the left rear quarter panel of the vehicle 14, the second panel 64 is typically attached to the right rear quarter panel of the vehicle 14. However, it is to be appreciated that the second panel 64 may be attached to any portion of the interior of the passenger compartment 12 of the vehicle 14. Further, in the embodiment where the first panel 16 includes at least one additional receptacle 30, the second panel 64 may also include at least one additional receptacle 30. However, in another embodiment, only one of the first panel 16 or the second panel 64 may include the at least one additional receptacle 30.

Specifically, as shown in FIG. 8, the second receptacle 66 typically defines a second periphery 68 including a locking member, generally indicated at 25. That is, the second receptacle 66 typically extends inwardly away from the interior of the passenger compartment 12 of the vehicle 14 to define the second periphery 68. It is to be appreciated that the second receptacle 66 may be disposed in any suitable location in the second panel 64. That is, the second receptacle 66 may be disposed centrally or near an edge of the second panel 64. The second receptacle 66 typically receives the second shell 50, as set forth in more detail below.

Without intending to be limiting, the locking member 25 may be defined as at least one tab. It is to be appreciated that the locking member 25 may be a flexible tab or a rigid tab. It is also to be appreciated that the locking member 25 may include a plurality of tabs or that the tabs may be eliminated. It is further to be appreciated that the locking member 25 may be a hook, a snap, a hook and loop fastener, e.g. Velcro®, a latch, a magnet, an interference fit, a friction fit, or any other acceptable locking member 25.

It is also to be appreciated that the locking member 25 may be disposed anywhere on the second periphery 68, proximal to the second periphery 68, or in any other suitable location. When in use, the locking member 25 typically retains the second shell 50 in the second receptacle 66 of the second panel 64, as set forth in more detail below.

The second periphery 68 typically defines the recession 26 extending away from the second receptacle 66. The recession 26 is typically opposite the locking member 25 of the second receptacle 66. That is, the recession 26 and the locking member 25 typically operate in tandem to retain the second shell 50 in the second receptacle 66 of the second panel 64. More specifically, the recession 26 typically retains the proximal portion of the second shell 50 while the locking member 25 typically retains the distal portion of the second shell 50. It is to be appreciated that the second periphery 68 may define a plurality of recessions 26, for example, two recessions 26, 27 with each recession 26, 27 extending away from the second receptacle 66. In an embodiment where the second periphery 68 defines a plurality of recessions 26, 27, each recession 26, 27 is typically disposed equidistant apart from a central axis A.

The second periphery 68 typically defines the well 28 spaced apart from the recession 26 and opposite the locking member 25 of the second receptacle 66. The well 28 is typically opposite the locking member 25 of the second receptacle 66. The well 28 may be a seat for the second portion 60 of the hinge 56 of the second shell 50. That is, the well 28 and the locking member 25 typically also operate in tandem to retain the second shell 50 in the second receptacle 66 of the second panel 50. More specifically, the well 28 typically retains the second portion 60 of the hinge 56 of the second shell 50 while the locking member 25 typically retains the distal portion of the second shell 50. It is to be appreciated that the second periphery 68 may define a plurality of wells 28, for example, two wells 28, 29, with each well 28, 29 extending away from the second receptacle 66. In an embodiment where the second periphery 68 defines a plurality of wells 28, 29, each well 28, 29 is typically disposed equidistant apart from a central axis A.

In one embodiment, the second panel 64 further comprises the additional receptacle 30. The additional receptacle 30 is different from the second receptacle 66. As shown in FIG. 8, the additional receptacle 30 typically defines the additional periphery 32. That is, the additional receptacle 30 typically extends inwardly away from the interior of the passenger compartment 12 of the vehicle 14 towards the exterior of the vehicle 14 to define the additional periphery 32. It is to be appreciated that the additional receptacle 30 may be disposed in any suitable location in the second panel 64. That is, the additional receptacle 30 may be disposed centrally or near an edge of the second panel 64.

The additional receptacle 30 typically includes the retainer 34. The retainer 34 is typically the cargo net, i.e., flexible and stretchable netting, that is attached to the additional periphery 32 of the additional receptacle 30. However, it is to be appreciated that the retainer 34 may include a plurality of cargo nets or that the cargo nets may be eliminated. It is further to be appreciated that the retainer 34 may be any means for retaining, such as a hook, a snap, a hook and loop fastener, e.g. Velcro®, a latch, an arm, a magnet, an interference fit, a friction fit, or any other acceptable retainer 34. It is also to be appreciated that the retainer 34 may be disposed anywhere on the additional periphery 32, proximal to the additional periphery 32, or in any other suitable location.

Referring to FIG. 4, in one embodiment, the trim assembly 10 further comprises a plurality of storage bags, generally indicated at 36, 37. The plurality of storage bags 36, 37 are typically soft-sided and moldable. That is, the plurality of storage bags 36, 37 are typically fabricated from a fabric or flexible plastic. The plurality of storage bags 36, 37 typically include at least one opening for insertion of items 80 to be stored. The storage bag 37 or plurality of storage bags 36, 37 is typically removably retained within the additional receptacle 30 of the second panel 64 by the retainer 34. That is, the retainer 34 typically retains the storage bag 37 or plurality of storage bags 36, 37 in the additional receptacle 30 of the second panel 64. When in use, the additional receptacle 30 typically receives the storage bag 37 or plurality of storage bags 36, 37, and when not in use, the storage bag 37 or plurality of storage bags 36, 37 may be removed from the additional receptacle 30 and/or from the vehicle 14.

Referring to FIGS. 6 and 8, in the embodiment comprising the second panel 64 including the second receptacle 66, the second shell 50 typically further comprises the protrusion 42 that is complementary in configuration to the recession 26 of the second periphery 68 of the second receptacle 66. The protrusion 42 is typically useful as a locating peg for removably coupling the second shell 50 within the second receptacle 66. That is, to removably couple the second shell 50 within the second receptacle 66, a user typically aligns the protrusion 42 with the recession 26 so that the recession 26 receives the protrusion 42. Since the protrusion 42 is complementary in configuration to the recession 26 of the second receptacle 66, the protrusion 42 typically fits snugly within and is surrounded by the recession 26.

Further, in an embodiment including the plurality of protrusions 42, 43, the plurality of protrusions 42, 43 of the first shell 18 are typically spaced farther and equidistant from the central axis A than the plurality of protrusions 42, 43 of the second shell 50. That is, as shown in FIG. 6, the protrusion 42 of the first shell 18 is spaced apart from and opposite, i.e., offset, the protrusion 43 of the second shell 50. Without intending to be limited by theory, it is believed that a configuration of the plurality of protrusions 42, 43 as set forth above provides the case 52 with stability when the case 52 is in a vertical position, i.e., standing on the plurality of protrusions 42, 43.

For the second shell 50, the indentation 44 is complementary in configuration to the locking member 25 of the second periphery 68 of the second receptacle 66. The indentation 44 is typically useful as a retention means for removably coupling the second shell 50 within the second receptacle 66. That is, to removably couple the second shell 50 within the second receptacle 66, a user typically aligns the protrusion 42 with the recession 26 so that the recession 26 receives the protrusion 42, which thereby aligns the indentation 44 with the locking member 25 so that the indentation 44 receives the locking member 25, and removably couples, i.e., lodges, the second shell 50 into place within the second receptacle 66. Since the indentation 44 is complementary in configuration to the locking member 25 of the second receptacle 66, the locking member 25 typically fits snugly within and is surrounded by the indentation 44.

Notably, the first shell 18 is typically removably coupled within the first receptacle 20 and the second shell 50 is typically removably coupled within the second receptacle 66 prior to attaching the first panel 16 and the second panel 64 to the interior of the passenger compartment 12 of the vehicle 14. That is, the trim assembly 10 may be supplied to a manufacturer of the vehicle 14 as a plurality of integrated units, i.e., as a plurality of prefabricated units. Consequently, the trim assembly 10 typically minimizes production costs associated with component tracking and vehicle assembly.

In the embodiment comprising the second panel 64 including the second receptacle 66, the second shell 50 is typically removably coupled within the second receptacle 66 so that one of the convex surface 38 and the concave surface 40 is exposed. That is, the second shell 50 is removable from the second receptacle 66 and/or from the vehicle 14. However, as set forth above, the second shell 50 may be uncoupled from the first shell 18. That is, the second shell 50 may be removably coupled to the first shell 18 to define the case 52.

Referring to FIG. 9, when in use for storage in the vehicle 14, the second shell 50 is typically substantially received within the second receptacle 66 so that the second shell 50 is disposed substantially flush to the second panel 64. It is to be appreciated that the terminology substantially flush means that the second shell 50 is typically seated within the second receptacle 66 of the second panel 64 so that the second shell 50 does not encroach into the interior of the passenger compartment 12 of the vehicle 14. The concave surface 40 of the second shell 50 is typically visible from the interior of the passenger compartment 12 of the vehicle 14, but is recessed within the second panel 64 so as not to encroach into the passenger compartment 12 of the vehicle 14, thus allowing for transportation of large or bulky items 80 in the passenger compartment 12 of the vehicle 14.

Referring to FIGS. 2 and 9, in another embodiment, the trim assembly 10 may further comprise at least an additional shell, generally indicated at 70, removably coupled to the first shell 18. The at least additional shell 70 is typically substantially similar to the first shell 18. That is, the at least additional shell 70 typically mates with the first shell 18 to form the case 52. The at least additional shell 70 typically defines a convex surface 38 and a concave surface 40. The at least additional shell 70 is matable to the first shell 18 to define the case 52 that is removable from the first receptacle 20 of the first panel 16. Additionally, the case 52 is also removable from the vehicle 14.

The case 52 is removable from the interior of the passenger compartment 12 of the vehicle 14 and provides a transportable, removable storage space for items 80. That is, the at least additional shell 70 typically includes five sides to define a storage space. The at least additional shell 70 is removably coupled, i.e., mated, to the first shell 18 to define the case 52 which encloses the storage space. It is to be appreciated that the first shell 18 may be mated to the at least additional shell 70 to define the case 52 inside the passenger compartment 12 of the vehicle 14, i.e., in the first receptacle 20, or may be mated to define the case 52 outside the passenger compartment 12 of the vehicle 14.

In one embodiment, the trim assembly 10 may further comprise a second additional shell 71, i.e., two additional shells 70, 71. The second additional shell 71 is typically removably coupled to the second shell 50. Further, the second additional shell 71 is typically substantially similar to the second shell 50. The second additional shell 71 typically defines a convex surface 38 and a concave surface 40.

It is to be appreciated that in an embodiment including the second additional shell 71, i.e., two additional shells 70, 71, the first shell 18 and the second shell 50 each independently removably couple, i.e., mate, with the two additional shells 70, 71 to form two cases 52, 53. That is, the second additional shell 71 typically mates with the second shell 50 to form the case 53. In this embodiment, each case 52, 53 is respectively removably coupled within the first receptacle 20 of the first panel 16 and the second receptacle 66 of the second panel 64. That is, the second additional shell 71 is typically matable to the second shell 50 to define the case 53 that is removable from the second receptacle 66 of the second panel 64.

It is to be appreciated that each case 52, 53 is removable from the vehicle 14, provides a transportable, removable storage space for items 80, and includes substantially similar features as set forth above. That is, the second shell 71 typically also includes five sides to define a storage space. It is to be appreciated that the second shell 50 may be mated to the second additional shell 71 to define the case 53 inside the passenger compartment 12 of the vehicle 14, i.e., in the second receptacle 66, or may be mated to define the case 53 outside the passenger compartment 12 of the vehicle 14.

In this embodiment, it is also to be appreciated that the two additional shells 70, 71 are each different from another so that the at least additional shell 70 mates with the first shell 18 and the second additional shell 71 mates with the second shell 50. That is, the at least additional shell 70 that is matable and removably coupled to the first shell 18 includes features of and is substantially similar to the second shell 50 as set forth above. In contrast, the second additional shell 71 that is matable and removably coupled to the second shell 50 includes features of and is substantially similar to the first shell 18 as set forth above.

The case 52 or plurality of cases 52, 53, whether defined by the first shell 18 removably coupled to the second shell 50, the first shell 18 removably coupled to the additional shell 70, and/or the second shell 50 removably coupled to the second additional shell 71, minimize transfer of stored items 80 to other storage and transportation means before the items 80 are removed from the vehicle. That is, since the case 52 and plurality of cases 52, 53 are removable from the vehicle 14, the user does not have to transfer items 80 to another storage and transportation means before carrying the items 80 outside the vehicle 14. The case 52 secures and protects stored items 80 and remains removably coupled to the first panel 16 or the second panel 64 of the vehicle 14 during vehicle use.

Referring to FIG. 5, the second additional shell 71 may further comprise the closure means 46. The closure means is typically useful for ensuring that the second additional shell 71 remain mated, i.e., that the case 52 remains in a closed position.

The case 52, defined by the first shell 18, the second shell 50, and/or the at least additional shell 70 and the second additional shell 71 are typically formed from a polymer, such as a thermoplastic or any other material or combination of materials that provides the case 52 with strength and rigidity, such that the case 52 bends and flexes little. The first shell 18, the second shell 50, the at least additional shell 70, and the second additional shell 71 may be formed by molding methods known in the art, such as blow molding, injection molding, etc. The case 52 is sturdy and protects against damage to stored items 80 from jostling or puncture. Further, the case 52 may be of any color or combination of colors for aesthetic purposes, such as black, orange, white, silver, etc., and may include reflective markings.

In operation, the first shell 18 is typically removably coupled within the first receptacle 20 of the first panel 16 and removably coupled to the second shell 50 to define the case 52. In another embodiment, the second shell 50 may be uncoupled from the first shell 18 and removably coupled within the second receptacle 66 of the second panel 64. In another embodiment, the trim assembly 10 may include the plurality of cases 52, 53. In this embodiment, the first shell 18 may be removably coupled within the first receptacle 20 of the first panel 16 and removably coupled to the at least additional shell 70 to form the case 52. Additionally, the second shell 50 may be removably coupled within the second receptacle 66 of the second panel 64 and removably coupled to the second additional shell 71 to form the case 53. Further, the embodiments as set forth above may include the storage bag 36 or the plurality of storage bags 36, 37 retained within the additional receptacle 30 or the plurality of additional receptacles 30, 31 of the first panel 16 and/or the second panel 64.

The trim assembly 10 of the present invention is useful for providing additional storage space in the interior of the passenger compartment 12 of the vehicle 14. The trim assembly 10 typically secures loose items 80 sufficiently and minimizes ejection of loose items 80 into the passenger compartment of the vehicle 14, thereby minimizing risks to vehicle occupants. As such, it is to be appreciated that the case 52 may be defined as a pet container; an entertainment system, such as a radio, iPod, DVD player, television, etc.; a storage container, such as luggage; a safety equipment container; a first aid kit; a child care accessories container; or a charging device for recharging batteries. For the charging device and entertainment system, the trim assembly 10 may include a power source that is coupled to an electrical system of the vehicle 14 for providing electricity.

The invention has been described in an illustrative manner, and it is to be understood that the terminology which has been used is intended to be in the nature of words of description rather than of limitation. Obviously, many modifications and variations of the present invention are possible in light of the above teachings. The invention may be practiced otherwise than as specifically described.

What is claimed is:

1. A trim assembly for an interior of a passenger compartment of a vehicle comprising:
a first panel forming interior trim for the vehicle and defining a first receptacle;
a first shell defining a convex surface and a concave surface and removably coupled within said first receptacle so that one of said convex surface and said concave surface is exposed; and
a second shell defining a convex surface and a concave surface and being matable to said first shell to define a case, said case being removable from said first receptacle.

2. A trim assembly as set forth in claim 1 wherein said case is removably coupled within said first receptacle prior to attaching said first panel to the interior of the passenger compartment of the vehicle.

3. A trim assembly as set forth in claim 1 wherein said first receptacle defines a first periphery including a locking member.

4. A trim assembly as set forth in claim 3 wherein said first periphery defines a recession extending away from said first receptacle.

5. A trim assembly as set forth in claim 4 wherein said recession is opposite said locking member of said first receptacle.

6. A trim assembly as set forth in claim 4 wherein said first periphery defines a well spaced apart from said recession and opposite said locking member of said first receptacle.

7. A trim assembly as set forth in claim 4 wherein said first shell further comprises a protrusion that is complementary in configuration to said recession of said first periphery of said first receptacle.

8. A trim assembly as set forth in claim 7 wherein said first shell further defines an indentation that is opposite said protrusion of said first shell.

9. A trim assembly as set forth in claim 1 wherein said first shell is substantially received within said first receptacle so that said first shell is disposed substantially flush to said first panel.

10. A trim assembly as set forth in claim 1 wherein said first shell further comprises a lip.

11. A trim assembly as set forth in claim 1 wherein said second shell further comprises a protrusion.

12. A trim assembly as set forth in claim 11 wherein said second shell further defines an indentation that is opposite said protrusion of said second shell.

13. A trim assembly as set forth in claim 1 wherein said second shell is removably coupled to said first shell via an interference fit so that said lip of said second shell contacts and surrounds said first shell.

14. A trim assembly as set forth in claim 1 wherein said second shell is removably coupled to said first shell via a hinge.

15. A trim assembly as set forth in claim 1 wherein said first shell and said second shell each respectively include five sides to define a storage space.

16. A trim assembly as set forth in claim 1 further comprising at least an additional shell removably coupled to said first shell.

17. A trim assembly as set forth in claim 1, wherein said first shell or said second shell further comprises a handle.

18. A trim assembly as set forth in claim 17 wherein said handle is retractable.

19. A trim assembly as set forth in claim 1 wherein said first shell and/or said second shell comprises a retainer.

20. A trim assembly for an interior of a passenger compartment of a vehicle comprising:
a first panel defining a first receptacle;
a first shell defining a convex surface and a concave surface and removably coupled within said first receptacle so that one of said convex surface and said concave surface is exposed;
a second shell defining a convex surface and a concave surface and being matable to said first shell to define a case, said case being removable from said first receptacle; and
a second panel opposing said first panel and defining a second receptacle for receiving said second shell independently from said first shell.

21. A trim assembly as set forth in claim 20 wherein said case is removably coupled within said first receptacle prior to attaching said first panel to the interior of the passenger compartment of the vehicle.

22. A trim assembly as set forth in claim 20 wherein said second panel is substantially similar to said first panel.

23. A trim assembly as set forth in claim 20 wherein said second receptacle defines a second periphery comprising a locking member.

24. A trim assembly as set forth in claim 23 wherein said second periphery defines a recession extending away from said second receptacle.

25. A trim assembly as set forth in claim 24 wherein said recession is opposite said locking member of said second receptacle.

26. A trim assembly as set forth in claim 24 wherein said second periphery defines a well spaced apart from said recession and opposite said locking member of said second receptacle.

27. A trim assembly as set forth in claim 24 wherein said second shell further comprises a protrusion that is complementary in configuration to the recession of said second periphery of said second receptacle.

28. A trim assembly as set forth in claim 27 wherein said second shell further defines an indentation that is opposite said protrusion of said second shell.

29. A trim assembly as set forth in claim 20 wherein said second shell is removably coupled within said second receptacle.

30. A trim assembly as set forth in claim 20 wherein said second shell is uncoupled from said first shell.

31. A trim assembly as set forth in claim 29 wherein said second shell is substantially received within said second receptacle so that said second shell is disposed substantially flush to said second panel.

32. A trim assembly as set forth in claim 29 wherein said first shell is removably coupled within said first receptacle and said second shell is removably coupled within said second receptacle prior to attaching said first panel and said second panel to the interior of the passenger compartment of the vehicle.
